(19) United States
(12) Patent Application Publication
(10) Pub. No.: US 2022/0377779 A1
(43) Pub. Date: Nov. 24, 2022

(54) SCHEDULING METHOD, TERMINAL, AND NETWORK SIDE DEVICE

(71) Applicant: VIVO MOBILE COMMUNICATION CO., LTD., Dongguan (CN)

(72) Inventors: Zichao JI, Dongguan (CN); Gen LI, Dongguan (CN); Xueming PAN, Dongguan (CN); Siqi LIU, Dongguan (CN)

(73) Assignee: VIVO MOBILE COMMUNICATION CO., LTD., Dongguan (CN)

(21) Appl. No.: 17/881,868

(22) Filed: Aug. 5, 2022

Related U.S. Application Data
(63) Continuation of application No. PCT/CN2021/075002, filed on Feb. 3, 2021.

(30) Foreign Application Priority Data
Feb. 6, 2020 (CN) 202010081515.4

(51) Int. Cl. H04W 72/12

(52) U.S. Cl. CPC H04W 72/1278

(57) ABSTRACT

A scheduling method, a terminal, and a network side device are provided. The scheduling method performed by the terminal includes: obtaining scheduling configuration information; and monitoring scheduling information of at least two scheduling objects to schedule one scheduled object based on the scheduling configuration information.

### CROSS-REFERENCE TO RELATED APPLICATIONS

This application is a continuation of International Application No. PCT/CN2021/075002, filed Feb. 3, 2021, which claims priority to Chinese Patent Application No. 202010081515.4, filed Feb. 6, 2020. The entire contents of each of the above-referenced applications are expressly incorporated herein by reference.

### TECHNICAL FIELD

Embodiments of the present disclosure relate to the field of wireless communications technologies, and in particular, to a scheduling method, a terminal, and a network side device.

### BACKGROUND

The 5G New Radio (NR) system supports carrier aggregation (CA), which may configure and activate a plurality of component carriers (CC) or cells for User Equipment (UE, also referred to as a terminal), and supports cross-carrier scheduling under the CA. When the UE is configured to be in a single carrier mode or a self-scheduling mode under the CA, each CC or cell may be configured with a plurality of control resource sets (CORESET) and a plurality of search spaces (SS), including a common search space (CSS) and a UE-specific search space (USS). The network may flexibly configure the quantity of blind detections for each search space set, and the CORESET may be flexibly associated with the search space set. Based on the configured CORESET and SS, the UE blindly detects a physical downlink control channel (PDCCH) by using various Radio Network Temporary Identifier (RNTI), and Downlink Control Information (DCI), to obtain scheduling information of each cell. Each piece of DCI is used to schedule data of one cell.

If channel qualities of some cells are not good enough, or a channel blocking probability is relatively high, the network may configure the cross-carrier scheduling for the UE, namely, a control channel is configured in a cell with a better channel quality (for example, a PCell) to schedule data of other cells (for example, an SCell) in a cross-carrier manner. A subcarrier spacing (SCS) of a scheduling cell may be the same or different from a subcarrier spacing of a scheduled cell. The scheduling cell may be in a self-scheduling mode, and in this case, the cell only schedules itself. If configured with the cross-carrier scheduling, the scheduling cell may also schedule one or more scheduled cells other than the scheduling cell. The scheduled cell does not have a PDCCH, and can only be scheduled by one scheduling cell.

In the Release 15 NR system, one cell can only be scheduled by one scheduling cell (namely, the cell can only be scheduled by itself or by another cell), and the PCell can only be scheduled by the PCell itself. This results in less flexibility in scheduling.

### SUMMARY

Embodiments of the present disclosure provide a scheduling method, a terminal, and a network side device.

According to a first aspect, an embodiment of the present disclosure provides a scheduling method, performed by a terminal and including:

obtaining scheduling configuration information; and

monitoring scheduling information of at least two scheduling objects to schedule one scheduled object based on the scheduling configuration information.

According to a second aspect, an embodiment of the present disclosure provides a scheduling method, where the method is performed by a network side device and includes:

sending scheduling configuration information, where the scheduling configuration information at least includes: scheduling information that configures a terminal to monitor at least two scheduling objects to schedule one scheduled object.

According to a third aspect, an embodiment of the present disclosure provides a terminal, including:

an obtaining module, configured to obtain scheduling configuration information; and

a monitoring module, configured to monitor scheduling information of at least two scheduling objects to schedule one scheduled object based on the scheduling configuration information.

According to a fourth aspect, an embodiment of the present disclosure provides a network side device, including:

a sending module, configured to send scheduling configuration information, where the scheduling configuration information at least includes: scheduling information that configures a terminal to monitor at least two scheduling objects to schedule one scheduled object.

According to a fifth aspect, an embodiment of the present disclosure provides a terminal, including a processor, a memory, and a computer program stored in the memory and executable on the processor, and when the computer program is executed by the processor, steps of the scheduling method provided in the first aspect are implemented.

According to a sixth aspect, an embodiment of the present disclosure provides a network side device, including a processor, a memory, and a computer program stored in the memory and executable on the processor, where when the computer program is executed by the processor, steps of the scheduling method provided in the second aspect are implemented.

According to a seventh aspect, an embodiment of the present disclosure provides a computer-readable storage medium, where the computer-readable storage medium stores a computer program, and when the computer program is executed by a processor, the steps of the scheduling method provided in the first aspect are implemented; or when the computer program is executed by a processor, the steps of the scheduling method provided in the second aspect are implemented.

According to an eighth aspect, an embodiment of the present disclosure provides a computer program product, where when the program product is executed by at least one processor, the steps of the scheduling method provided in the first aspect are implemented; or the steps of the scheduling method provided in the second aspect are implemented.

According to a ninth aspect, an embodiment of the present disclosure provides a communication device, where the communication device is configured to implement the steps of the scheduling method provided in the first aspect; or the steps of the scheduling method provided in the second aspect.

In the embodiments of the present disclosure, at least two scheduling objects may be used to schedule one scheduled object. Compared with the related art, in which one cell can only, be scheduled by one scheduling cell, the flexibility of scheduling is improved.

### BRIEF DESCRIPTION OF DRAWINGS

The accompanying drawings are merely used to show preferred implementation manners, and are not considered as limitations to the present disclosure. In addition, in all the accompanying drawings; a same reference symbol is used to represent a same part. In the accompanying drawings:

FIG. 1 is a schematic architectural diagram of a wireless communications system according to an embodiment of the present disclosure;

FIG. 2 is a schematic flowchart of a scheduling method according to an embodiment of the present disclosure;

FIG. 3 and FIG. 4 are schematic diagrams of an SCell scheduling a PCell in a cross-carrier manner according to an embodiment of the present disclosure;

FIG. 5, FIG. 6, and FIG. 7 are schematic diagrams of multi-TRP transmission scenarios according to an embodiment of the present disclosure;

FIG. 8 is a schematic flowchart of a scheduling method according to another embodiment of the present disclosure;

FIG. 9 is a schematic diagram of a structure of a terminal according to an embodiment of the present disclosure;

FIG. 10 is a schematic structural diagram of a network side device according to an embodiment of the present disclosure;

FIG. 11 is a schematic diagram of a structure of a terminal according to another embodiment of the present disclosure;

FIG. 12 is a schematic structural diagram of a terminal according to still another embodiment of the present disclosure; and

FIG. 13 is a schematic structural diagram of a network side device according to an embodiment of the present disclosure.

### DETAILED DESCRIPTION

The term “include” and any other variants in the specification and claims of this application mean to cover the non-exclusive inclusion, for example, a process, method, system, product, or device that includes a list of steps or units is not necessarily limited to those steps or units, but may include other steps or units not expressly listed or inherent to such a process, method, product, or device. In addition, “and/or” used in the description and the claims means at least one of the connected objects. For example, A and/or B represents the following three cases: Only A exists, only B exists, and both A and B exist.

In the embodiments of the present disclosure, the term such as “exemplary” or “for example” is used to represent an example, an instance, or a description. Any embodiment or design solution described as “exemplary” or “for example” in the embodiments of the present disclosure should not be construed as being more preferred or advantageous than other embodiments or design solutions. To be precise, the use of the term such as “exemplary” or “for example” is intended to present a related concept in a specific manner.

Embodiments of the present disclosure will be described below with reference to the accompanying drawings. A scheduling method, a terminal, and a network side device provided in the embodiments of the present disclosure may be performed by a wireless communications system. The wireless communications system may be a 5G system, an Evolved Long Term Evolution (eLTE) system, or a subsequent evolved communications system.

Referring to FIG. 1, FIG. 1 is a schematic architectural diagram of a wireless communications system according to an embodiment of the present disclosure. As shown in FIG. 1, the wireless communications system may include: a network side device 11 and a terminal 12. The terminal 12 may be connected to the network side device 11. In actual application, a connection between the foregoing devices may be a wireless connection. To conveniently and intuitively represent a connection relationship between the devices, a solid line is used for illustration in FIG. 1.

It should be noted that the communications system may include a plurality of terminals 12, and the network side device 11 may communicate (transmit signaling or data) with the plurality of terminals 12.

The network side device 11 provided in this embodiment of the present disclosure may be a base station. The base station may be a commonly used base station, or may be an evolved node base station (eNB), or may be further a device such as a network side device (for example, a next generation node base station (gNB) or a transmission and reception point (TRP)) in a 5G system, or a cell, or may be a network side device in a subsequent evolved communications system.

The terminal 12 provided in this embodiment of the present disclosure may be a mobile phone, a tablet computer, a notebook computer, an Ultra-Mobile Personal Computer (UMPC), a netbook, a Personal Digital Assistant (PDA), or the like.

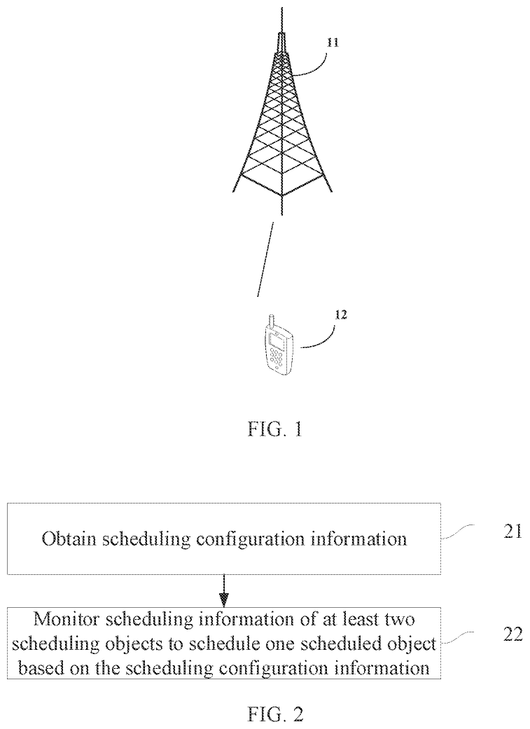

Referring to FIG. 2, FIG. 2 is a schematic flowchart of a scheduling method according to an embodiment of the present disclosure. The scheduling method is performed by a terminal and includes:

Step 21: Obtain scheduling configuration information.

Step 22: Monitor scheduling information of at least two scheduling objects to schedule one scheduled object based on the scheduling configuration information.

In the embodiments of the present disclosure, at least two scheduling objects may be used to schedule one scheduled object. Compared with the related art, in which one cell can only be scheduled by one scheduling cell, the flexibility of scheduling is improved.

In this embodiment of the present disclosure, the scheduling configuration information may be obtained in at least one of the following manners: a network side configuration, a pre-configuration, or a protocol agreement. For example, a part of the scheduling configuration information is configured by the network side, and a part of the scheduling configuration information is agreed upon in a protocol.

In this embodiment of the present disclosure, the scheduling object may be a cell. That is, in some embodiments of the present disclosure, the terminal monitors the scheduling information of at least two scheduling cells to schedule one scheduled cell, for example, monitoring scheduling information for a cell 1 and a cell 2 to schedule the cell 1, the cell 2, or a cell 3.

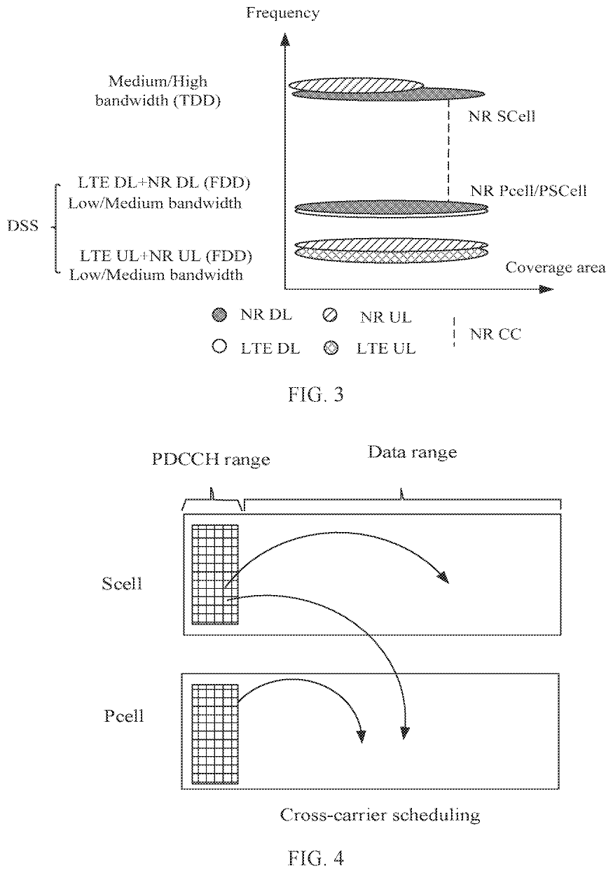

In the related art, for the consideration of enhancing the coverage of the control channel, a primary cell (PCell) is usually deployed on a carrier in a low frequency band. On the other hand, a bandwidth of the carrier in the low frequency band is insufficient and has been heavily deployed to other series (for example, the LTE). Please refer to FIG. 3 and FIG. 4. At this time, a carrier in a high frequency band may be configured as a Secondary Cell (SCell), and the PCell may be scheduled through the SCell to increase PCell control channel capacity, thereby reducing the overhead of the control channel such as the PDCCH.

That is, in the embodiments of the present disclosure, the scheduled object is the PCell, and the scheduling Objects include the SCell. For example, the PCell may be scheduled by itself, and may also be scheduled through the SCell in a cross-carrier manner.

In this embodiment of the present disclosure, the scheduling objects may also be a Transmission and Reception Point (TRP), that is, the search space of the scheduling objects is associated with a specific CORESET or CORESET pool.

The following briefly describes a multi-TRP transmission scenario.

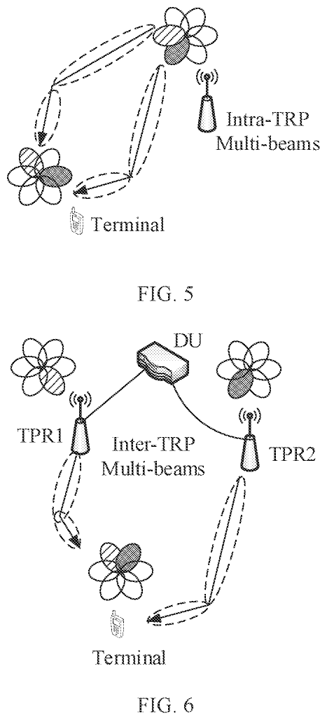

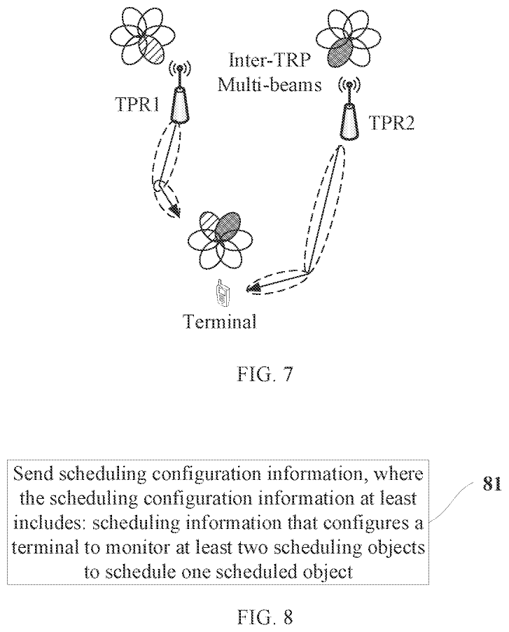

A scenario of multi-TRP/multi-panel is proposed in 3GPP Rel-16, and the multi-TRP transmission may increase the reliability and throughput performance of transmission. For example, the terminal may receive same data or different data from a plurality of TRPs. Some multi-TRP transmission scenarios are shown in FIG. 5, FIG. 6, and FIG. 7:

1) multi-antenna panel transmission within a same TRP is shown in FIG. 5;

2) multi-TRP/panel transmission among a plurality of TRPs and an ideal backhaul are shown in FIG. 6; and

3) multi-TRP/panel transmission among a plurality of TRPs and a non-ideal backhaul are shown in FIG. 7.

The scheduling method in the embodiments of the present disclosure may be performed by the multi-TRP transmission scenario, that is, the terminal may monitor scheduling information of at least two TRPs to schedule one TRP. For example, monitoring the scheduling information for a TRP 1 and a TRP 2 to schedule the TRP 1, the TRP 2, or a TRP 3.

Since the terminal needs to monitor the scheduling information of at least two scheduling Objects to schedule one scheduled object, if a relevant cross-carrier scheduling framework is simply applied only, the demodulation complexity of the terminal may be greatly increased, for example, more buffering or larger demodulation capability is required, which is not conducive to the realization of the terminal.

In order to reduce the complexity of realizing the terminal, in some embodiments of the present disclosure, the monitoring scheduling information of at least two scheduling objects to schedule one scheduled object based on the scheduling configuration information includes: monitoring a search space on the scheduled object and/or the scheduling Objects based on quantity information and/or type information of search space monitoring in the scheduling configuration information.

In some embodiments, the quantity information and/or the type information of search space monitoring includes at least one of the following:

1) not monitoring a UE-specific search space on the scheduled object;

For example, if the terminal is configured to schedule the PCell through the SCell in a cross-carrier manner, the terminal does not monitor the UE-specific search space (the UE-specific search space may be referred to as S-P-USS hereinafter) on the PCell, thereby reducing the complexity of realizing the terminal.

This includes restrictions on the type information of search space monitoring.

2) a quantity of LE-specific search spaces monitored on the scheduled object does not exceed a first value;

For example, if the terminal is configured to schedule the PCell through the SCell in a cross-carrier manner, no more than the first value of S-P-USSs are monitored by the terminal on the PCell only, thereby reducing the complexity of realizing the terminal. For example, only one or two S-P-USSs is/are monitored on each bandwidth part (BWP) of the PCell.

This includes restrictions on the type information and the quantity information of search space monitoring.

3) not monitoring a unicast schedule on a common search space of the scheduled object;

That is, a cell radio network temporary identity (C-RNTI), a modulation and coding scheme C-RNTI (MCS-C-RNTI), or a configure scheduling RNTI (CS-RNTI) is not monitored in the common search space of the scheduled object.

This includes restrictions on the type information of search space monitoring.

4) a quantity of UE-specific search spaces (the UE-specific search space may be referred to as C-P-USS hereinafter) monitored on the scheduling objects does not exceed a second value;

For example, if the terminal is configured to schedule the PCell through the SCell in a cross-carrier manner, no more than the second value of C-P-USSs are monitored by the terminal on the SCell.

This includes restrictions on the type information and the quantity information of search space monitoring.

5) only monitoring a specific UE-specific search space on the scheduling objects, and a quantity of monitored UE-specific search spaces does not exceed a third value;

For example, if the terminal is configured to schedule the PCell through the SCell in a cross-carrier manner, the terminal only monitors scheduling for the PCell on the specific C-P-USS of the SCell, and a quantity of all monitored C-P-USSs does not exceed the third value.

This includes restrictions on the type information and the quantity information of search space monitoring.

6) a sum of the UE-specific search spaces monitored on the scheduled object and the quantity of UE-specific search spaces monitored on the scheduling objects does not exceed a fourth value;

For example, if the terminal is configured to schedule the PCell through the SCell in a cross-carrier manner, a sum of a quantity of C-P-USSs monitored by the terminal on the SCell and a quantity of S-P-USSs monitored by the terminal on the PCell does not exceed the fourth value.

This includes restrictions on the type information and the quantity information of search space monitoring.

7) a sum of a quantity of common search spaces monitored on the scheduled object and the quantity of UE-specific search spaces monitored on the scheduling objects does not exceed a first value; and

For example, if the terminal is configured to schedule the PCell through the SCell in a cross-carrier manner, a sum of a quantity of C-P-USSs monitored by the terminal on the SCell and a quantity of CSSs monitored by the terminal on the PCell does not exceed the fifth value.

This describes restrictions on the type information and the quantity information of search space monitoring.

8) a sum of a quantity of search spaces monitored on the scheduled objects and the quantity of UE-specific search spaces monitored on the scheduling objects does not exceed a sixth value.

For example, if the terminal is configured to schedule the PCell through the SCell in a cross-carrier manner, a sum of a quantity of C-P-USSs monitored by the terminal on the SCell and a quantity of SSs monitored by the terminal on the PCell does not exceed the sixth value.

This includes restrictions on the type information and the quantity information of search space monitoring.

Restrictions on the quantity information and/or the type information of monitoring may reduce the quantity of search spaces simultaneously monitored by the terminal, and reduce the complexity of realizing the terminal while maintaining the flexibility of the scheduling.

In order to further reduce the complexity of realizing the terminal, in the embodiments of the present disclosure, the monitoring scheduling information of at least two scheduling objects to schedule one scheduled object based on the scheduling configuration information includes: monitoring a search space on the scheduled object and/or the scheduling objects based on sequence information of search space monitoring in the scheduling configuration information.

In some embodiments, the sequence information of search space monitoring includes at least one of the following:

1) during a specific time, not simultaneously monitoring the search space on the scheduled object and the search space on the scheduling objects;

For example, if the terminal is configured to schedule the PCell through the SCell in a cross-carrier manner, the terminal does not simultaneously monitor any search space on the PCell and the C-P-USS on the SCell. In some embodiments, the terminal does not simultaneously monitor the S-P-USS on the PCell and the C-P-USS on the SCell.

2) during a specific time, monitoring, based on a priority rule, the search space of the scheduled object and all search spaces on the scheduling objects for scheduling the scheduled object.

In some embodiments, the priority rule includes at least one of the following:

21) monitoring a common search space preferentially;

22) monitoring a search space on a specific object preferentially, where the specific object is, for example, a PCell;

23) monitoring a search space with a lowest or highest preferentially;

24) monitoring a search space associated with a specific DCI format preferentially; or

25) monitoring a search space based on an II) order.

The restrictions on the sequence information of search space monitoring may be used to prevent the terminal from simultaneously processing scheduling instructions from two scheduling objects, thereby simplifying the complexity of realizing the terminal.

In order to further reduce the complexity of realizing the terminal, in the embodiments of the present disclosure, the monitoring scheduling information of at least two scheduling objects to schedule one scheduled object based on the scheduling configuration information includes: monitoring a unicast schedule of the scheduled object based on quantity information and/or type information of a unicast schedule in the scheduling configuration information.

In some embodiments, the quantity information and/or the type information of a uni cast schedule includes at least one of the following:

1) monitoring at most one or two unicast schedules associated with the scheduled object within a specific time;

For example, if the terminal is configured to schedule the PCell through the SCell in a cross-carrier manner, the terminal monitors at most one or two unicast schedules associated with the PCell.

2) monitoring at most one unicast schedule associated with the scheduled object on each object within a specific time; and

For example, if the terminal is configured to schedule the PCell through the SCell in a cross-carrier manner, the terminal monitors at most one unicast schedule associated with the PCell on each cell (the PCell and the Scell).

3) monitoring a specific type of unicast schedule associated with the scheduled object preferentially within a specific time.

For example, if the terminal is configured to schedule the PCell through the SCell in a cross-carrier manner, the terminal monitors a specific type of unicast schedule associated with the PCell preferentially.

In some embodiments, the specific type of unicast schedule includes: a unicast schedule in a specific DCI format, such as a type of fallback DCI (DCI format 1_0 or 0_0, and the like), or DCI used to simultaneously schedule a plurality of cells.

The restrictions on the quantity information and/or the type information of the unicast schedule may be used to prevent the terminal from simultaneously processing scheduling instructions from two scheduling objects, and to ensure that the terminal only needs to demodulate one unicast schedule at a time. Therefore, the complexity of realizing the terminal may be simplified, and the power consumption may be reduced.

In some embodiments, the specific time includes at least one of the following:

1) within a same moment; namely, a PDCCH monitoring occasion in an overlapping time;

2) within a same slot;

3) within a specific time interval;

In some embodiments, a start time and/or a duration of the specific time interval are/is related to parameters of at least two scheduling objects, for example, related to a numerology (a numerical configuration) or an SCS of the scheduling cell.

The specific time interval may be, for example, a time interval between PDCCH monitoring occasions of two scheduling objects.

4) a PDCCH monitoring occasion having a same earliest starting position for scheduling a PDSCH (physical downlink control channel) or a PUSCH (physical downlink shared channel); and

For example, PDCCH monitoring occasions on two scheduling cells where both the earliest starting positions of scheduling the PDSCH and the PUSCH are N.

5) within a running time of a monitoring timer.

In this embodiment of the present disclosure, the scheduling configuration information further includes: in a plurality of times of transmission for a same HARQ process or a same TB, only allowing scheduling from the same object. Therefore, it may be avoided that a soft buffer of the terminal simultaneously processes scheduling instructions from two scheduling objects, and buffer management of the terminal may be simplified.

In this embodiment of the present disclosure, the scheduling configuration information further includes: if an ID of a first search space on the scheduled object is the same as an ID of a second search space on the scheduling objects, but the first search space is a common search space, considering that the first search space and the second search space are not associated.

For example, if the terminal is configured to schedule the PCell through the SCell in a cross-carrier manner, the SS on the PCell and any SS on the SCell have a same SS ID, but a type of the SS is CSS, it is considered that the SS on the PCell is not associated with the SS with the same ID on the SCell, and a configuration field of the search space of the CSS is valid, that is, only the USS configured on the SCell is allowed to schedule the USS of the PCell in a cross-carrier manner, thereby simplifying the scheduling management of the terminal.

In this embodiment of the present disclosure, the scheduling method further includes:

reporting a terminal capability, where the terminal capability includes at least one of the following:

a quantity of monitored search spaces supported by the terminal;

a quantity of unicast schedules supported by the terminal;

c whether the terminal supports scheduling the scheduled object through the scheduling objects;

a quantity of HARQ processes associated with each object;

an earliest starting position of a scheduled PDSCH or PUSCH; or

a duration of a specific time interval or a monitoring timer.

For example, when a quantity of C-P-USSs reported by the terminal is 0, it indicates that the terminal does not support scheduling the scheduled object through the scheduling objects.

In the foregoing embodiment, that the Pcell is simultaneously scheduled by the PCell itself and the Scell is mainly taken as an example for illustration, but the scheduling method of the present disclosure is applicable to a scenario in which any cell is scheduled by two (or more) cells (for example, one Scell is simultaneously scheduled by the Pcell and the Scell, or one Scell is simultaneously scheduled by two Scells).

In the foregoing embodiment, the DCI for cross-carrier scheduling may be DCI for scheduling one cell independently, or DCI for scheduling a plurality of cells simultaneously. For example, that the Scell schedules the Pcell may be using a special piece of DCI to schedule data of the Scell and the Pcell simultaneously.

Referring to FIG. 8, an embodiment of the present disclosure further provides a scheduling method; performed by a network side device and including:

Step 81: Send scheduling configuration information, where the scheduling configuration information at least includes: scheduling information that configures a terminal to monitor at least two scheduling objects to schedule one scheduled object.

In some embodiments, the scheduling configuration information further includes at least one of the following:

quantity information and/or type information of search space monitoring;

sequence information of search space monitoring;

quantity information and/or type information of a unicast schedule; or

a DCI format of scheduling.

In some embodiments, the scheduling method further includes:

sending the scheduling configuration information based on a terminal capability reported by the terminal, where

the terminal capability includes at least one of the following:

a quantity of monitored search spaces supported by the terminal;

a quantity of unicast schedules supported by the terminal;

whether the terminal supports scheduling the scheduled object through the scheduling objects;

a quantity of HARQ processes associated with each object;

an earliest starting position of a scheduled PDSCH or PUSCH; or

a duration of a specific time interval or a monitoring timer.

The following describes the scheduling method of the present disclosure with reference to specific application scenarios.

### Embodiment 1 of the Present Disclosure

1. The network side device configures a Pcell and a Scell for the terminal, and configures the terminal to schedule the Pcell through the Scell in a cross-carrier manner.

2. The terminal only monitors the CSS (common search space) on the Pcell, and does not monitor the C-RNTI (cell radio network temporary identity) in the CSS, and only monitors, on the Scell, scheduling the C-RNTI on the Pcell in a cross-carrier manner.

In this embodiment of the present disclosure, the terminal only needs to monitor the broadcast or multicast of the CSS on the Pcell, thereby reducing the buffer management of the terminal and reducing the cross-process interaction between different cells of the Pcell and the Scell. Therefore, the complexity of realizing the terminal may be reduced to the greatest extent.

### Embodiment 2 of the Present Disclosure

1. The protocol specifies a maximum quantity of C-P-USSs and S-P-USSs that the terminal needs to monitor, or a maximum quantity of C-P-USSs and S-P-USSs that the terminal supports monitoring are reported by the terminal.

If the terminal reports that the C-P-USS is 0, it indicates that the terminal does not support the Scell in scheduling the Pcell in a cross-carrier manner.

2. The network side configures the Pcell and the Scell for the terminal, and the Scell schedules the Pcell through the C-P-USS in a cross-carrier manner, and the S-P-USS is configured on the Pcell for self-scheduling. In addition, a quantity of the C-P-USSs and the S-P-USSs does not exceed a maximum quantity of the C-P-USSs and the S-P-USSs monitored by the terminal.

3. The terminal only monitors the CSS on the Pcell, and may monitor the C-RNTI in the CSS and the S-P-USS. In order to avoid that the terminal needs to simultaneously monitor the self-scheduling of the Peel and cross-carrier scheduling of the Scell to the Pull:

a. the network side is not allowed to configure the C-P-USS to overlap (or conflict) with the S-P-USS; or

b. when the C-P-USS and the S-P-USS overlap (or conflict), the terminal only monitors scheduling of one of the cells, for example, only monitoring the self-scheduling of the Pcell (because the Pcell has better coverage performance, which may ensure the reliability of scheduling), or only monitoring scheduling of a cell where an SS with a lowest ID among overlapping SSs is located (so that the network side may freely choose a cell to schedule from by configuring the SS ID).

4. When the terminal monitors the scheduling on the Pcell:

a. An HARQ process of self-scheduling of the Pcell is different from an HARQ process of the Scell scheduling the Pcell in a cross-carrier manner; or

for a plurality of times of scheduling (initial transmission and HARQ retransmission) of a same TB, scheduling can only be performed from one cell. For example, if the Pcell schedules the initial transmission of a TB-1, retransmission of the TB-1 can only continue to be self-scheduled from the Pcell.

In this embodiment of the present disclosure, while supporting self-scheduling of the Pcell, the complexity of realizing the terminal may be reduced to a certain extent.

### Embodiment 3 of the Present Disclosure

When the network side configures the Pcell and the Scell for the terminal, and the Scell schedules the Pcell through the C-P-USS in a cross-carrier manner, and the S-P-USS is configured on the Nell for self-scheduling, in order to avoid that the terminal needs to simultaneously monitor self-scheduling of the Pcell and cross-carrier scheduling of the Scell to the Pcell:

a maximum quantity of pieces of unicast DCI monitored by the terminal on each scheduling cell may be specified, for example, the terminal monitors at most one piece of DCI of Pcell self-scheduling, and/or one piece of DCI of the Scell to schedule the Pcell in a cross-carrier manner; or

the terminal only needs to monitor one of the of Pcell self-scheduling or the DCI of the Scell to schedule the Pcell in a cross-carrier manner at the following moments (that is, the terminal will no longer detect the DCI of Pcell scheduling as long as detecting valid DCI of Peen scheduling from a cell):

i. when a PDCCH monitoring occasion of the Scell overlaps a PDCCH monitoring occasion of the Pcell; or

ii. all PDCCH monitoring occasions of the Scell and the Pcell in a same slot; or

iii. within a time window, for example, within every X radio frames or subframes or slots or OFDM symbols, in some embodiments, if the SCS of the Pcell is different from the SCS of the Scell, a length of the time window varies based on different SCSs.

Therefore, a processing time across different scheduling cells is reserved for the terminal.

In some embodiments, there may be a same PDCCH monitoring occasion at an earliest starting position of scheduling a PDSCH/PUSCH.

For example, for Nell self-scheduling, the earliest starting position of the PDCCH scheduling the PDSCH in a slot N is a slot N+0, and for cross-carrier scheduling, the earliest starting position of the PDCCH scheduling the PDSCH in the slot N is a slot N+k, then for the PDSCH scheduling of a slot M, the terminal only needs to monitor one valid scheduling DCI in monitoring occasions of the slot M and a slot M-k.

It may be further relaxed that the terminal only needs to monitor one valid scheduling DCI in all the monitoring occasions of a monitoring window slot [M, M-a] and a monitoring window slot [M-k, M-k-b], thereby further relaxing requirements of a processing capability of the terminal. The foregoing a, b, and k are time-domain lengths, and a unit may be a subframe, a slot, an OFDM symbol, or the like, which is not limited in the present disclosure.

### Embodiment 4 of the Present Disclosure

1. when the network side configures the Pcell and the Seen for the terminal, and configures a DCI format 1_a on the Pcell, the PDSCH of the Pcell and the PDSCH of the Scell may be scheduled simultaneously, and a self-scheduling DCI format 1_1 is configured for scheduling the Scell (which may be self-scheduling or cross-carrier scheduling).

2. When the terminal monitors a PDCCH:

a. one of the DCI 1_a of the Pcell or the DCI 1_1 of scheduling the Scell may be monitored at the same moment (a same monitoring occasion or a same slot monitoring occasion); or

b. one of the DCI 1_a of the Pcell or the DCI 1_1 of scheduling the Scell is preferentially selected for monitoring based on a priority, or a DCI format, or an ID (such as a cell ID or an SS ID); or

c. only one of the DCI 1_a of the Pcell or the DCI 1_1 of scheduling the Scell needs to be monitored in a time window, or there is a same PDCCH monitoring occasion in an earliest starting position of scheduling the PDSCH (referring to Embodiment 3 of the present disclosure).

In the scheduling method of the embodiments of the present disclosure, the terminal may support one cell (or TRP) to be scheduled by at least two scheduling cells (or TRP), and a quantity of SSs and a quantity of pieces of detected DCI simultaneously monitored by the terminal may be reduced while maintaining scheduling flexibility, so as to prevent the terminal from simultaneously processing scheduling instructions from two scheduling objects, and to ensure that the terminal only needs to demodulate one unicast schedule at a time. Therefore, the complexity of realizing the terminal may be simplified, and the power consumption may be reduced.

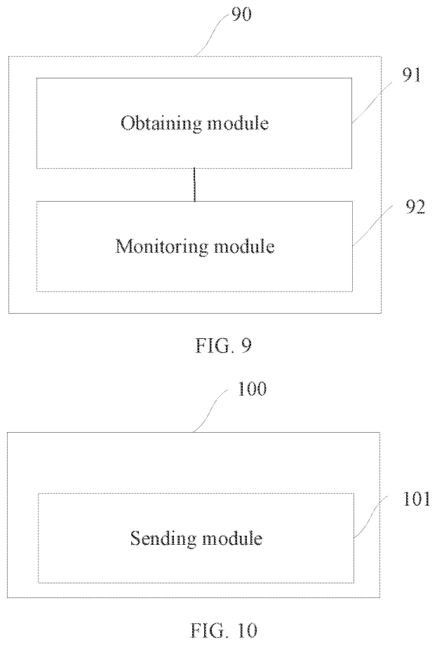

Referring to FIG. 9, an embodiment of the present disclosure further provides a terminal 90, including:

an obtaining module 91, configured to obtain scheduling configuration information; and

a monitoring module 92, configured to monitor scheduling information of at least two scheduling objects to schedule one scheduled object based on the scheduling configuration information.

In some embodiments, the monitoring module 92 is configured to monitor a search space on the scheduled object and/or the scheduling objects based on quantity information and/or type information of search space monitoring in the scheduling configuration information.

In some embodiments, the quantity information and/or the type information of search space monitoring includes at least one of the following:

not monitoring a UE-specific search space on the scheduled object;

a quantity of UE-specific search spaces monitored on the scheduled object does not exceed a first value;

not monitoring a uni cast schedule on a common search space of the scheduled object;

a quantity of UE-specific search spaces monitored on the scheduling objects does not exceed a second value;

only monitoring a specific UE-specific search space on the scheduling objects, and a quantity of monitored UE-specific search spaces does not exceed a third value;

a sum of the UE-specific search spaces monitored on the scheduled object and the quantity of UE-specific search spaces monitored on the scheduling objects does not exceed a fourth value;

a sum of a quantity of common search spaces monitored on the scheduled object and the quantity of UE-specific search spaces monitored on the scheduling objects does not exceed a first value; or

a sum of a quantity of search spaces monitored on the scheduled objects and the quantity of UE-specific search spaces monitored on the scheduling objects does not exceed a sixth value.

In some embodiments, the monitoring module 92 is configured to monitor a search space on the scheduled object and/or the scheduling objects based on sequence information of search space monitoring in the scheduling configuration information.

In some embodiments, the sequence information of search space monitoring includes at least one of the following:

during a specific time, not simultaneously monitoring the search space on the scheduled object and the search space on the scheduling objects; or

during a specific time, monitoring, based on a priority rule, the search space of the scheduled object and all search spaces on the scheduling objects for scheduling the scheduled object.

In some embodiments, the priority rule includes at least one of the following:

monitoring a common search space preferentially;

monitoring a search space on a specific object preferentially;

monitoring a search space with a lowest or highest ID preferentially;

monitoring a search space associated with a specific DCI format preferentially; or

monitoring a search space based on an ID order.

In some embodiments, the monitoring module 92 is configured to monitor a unicast schedule of the scheduled object based on quantity information and/or type information of a unicast schedule in the scheduling configuration information.

In some embodiments, the quantity information and/or the type information of a unicast schedule includes at least one of the following:

monitoring at most one or two unicast schedules associated with the scheduled object within a specific time;

monitoring at most one unicast schedule associated with the scheduled object on each object within a specific time; or

monitoring a specific type of unicast schedule associated with the scheduled object preferentially within a specific time.

In some embodiments, the specific type of unicast schedule includes: a unicast schedule in a specific DCI format.

In some embodiments, the specific time includes at least one of the following:

within a same moment;

within a same slot;

within a specific time interval;

a PDCCH monitoring occasion having a same earliest starting position for scheduling a PDSCH or a PUSCH; or

within a running time of a monitoring timer.

In some embodiments, the scheduling configuration information further includes: in a plurality of times of transmission for a same HARQ process or a same TB, only allowing scheduling from the same object.

In some embodiments, the scheduling configuration information further includes: if an ID of a first search space on the scheduled object is the same as an ID of a second search space on the scheduling objects, but the first search space is a common search space, considering that the first search space and the second search space are not associated.

In some embodiments, the terminal further includes:

a reporting module, configured to report a terminal capability, where the terminal capability includes at least one of the following:

a quantity of monitored search spaces supported by the terminal;

a quantity of unicast schedules supported by the terminal;

whether the terminal supports scheduling the scheduled object through the scheduling objects;

a quantity of HARQ processes associated with each object;

an earliest starting position of a scheduled PDSCH or PUSCH; or a duration of a specific time interval or a monitoring timer.

In some embodiments, the scheduled object is the PCell, and the scheduling objects include the SCell.

The terminal provided in the embodiments of the present disclosure can implement processes implemented by the terminal in the method embodiments of FIG. 2 to FIG. 7. To avoid repetition, details are not described herein again.

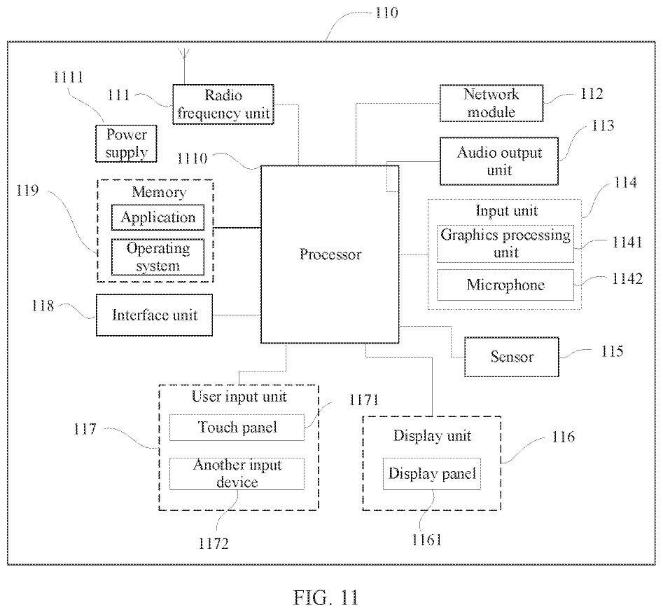

Referring to FIG. 10, an embodiment of the present disclosure further provides a network side device 100, including:

a sending module 101, configured to send scheduling configuration information, where the scheduling configuration information at least includes: scheduling information that configures a terminal to monitor at least two scheduling objects to schedule one scheduled object.

In some embodiments, the scheduling configuration information further includes at least one of the following:

quantity information and/or type information of search space monitoring;

sequence information of search space monitoring;

quantity information and/or type information of a unicast schedule; or

a DCI format of scheduling.

In some embodiments, the sending module is further configured to send the scheduling configuration information based on a terminal capability reported by the terminal, where

the terminal capability includes at least one of the following:

a quantity of monitored search spaces supported by the terminal;

a quantity of unicast schedules supported by the terminal;

whether the terminal supports scheduling the scheduled object through the scheduling objects;

a quantity of HARQ processes associated with each object;

an earliest starting position of a scheduled PDSCH or PUSCH; or

a duration of a specific time interval or a monitoring timer.

FIG. 11 is a schematic diagram of a hardware structure of a terminal for implementing the embodiments of the present disclosure. The terminal 110 includes but is not limited to components such as a radio frequency unit 111, a network module 112, an audio output unit 113, an input unit 114, a sensor 115, a display unit 116, a user input unit 117, an interface unit 118, a memory 119; a processor 1110, and a power supply 1111. A person skilled in the art may understand that a structure of the terminal shown in FIG. 11 does not constitute a limitation on the terminal, and the terminal may include more or fewer components than those shown in the figure, or combine some components, or have different component arrangements. In this embodiment of the present disclosure, the terminal includes hut is not limited to a mobile phone, a tablet computer, a laptop computer, a palmtop computer, an in-vehicle terminal, a wearable device; a pedometer, and the like.

The processor 1110 is configured to obtain scheduling configuration information; and monitor scheduling information of at least two scheduling objects to schedule one scheduled object based on the scheduling configuration information.

It should be understood that, in this embodiment of the present disclosure, the radio frequency unit 111 may be configured to receive and send information or a signal in a call process. In some embodiments, after receiving downlink data from a base station, the radio frequency unit 111 sends the downlink data to the processor 1110 for processing. In addition, the radio frequency unit 111 sends uplink data to the base station. Usually, the radio frequency unit 111 includes but is not limited to an antenna, at least one amplifier, a transceiver, a coupler, a low noise amplifier, a duplexer, and the like. In addition, the radio frequency unit 111 may communicate with a network and another device through a wireless communication system.

The terminal provides wireless broadband Internet access to a user through the network module 112, for example, helps the user receive and send e-mails, browse web pages, access streaming media, and the like.

The audio output unit 113 may convert audio data received by the radio frequency unit 111 or the network module 112 or stored in the memory 119 into an audio signal and output the audio signal as a sound. In addition, the audio output unit 113 may further provide an audio output (for example, a call signal received voice, or a message received voice) related to a specific function implemented by the terminal 110. The audio output unit 113 includes a loudspeaker, a buzzer, a telephone receiver, and the like.

The input unit 114 is configured to receive an audio signal or a video signal. The input unit 114 may include a Graphics Processing Unit (GPU) 1141 and a microphone 1142. The graphics processing unit 1141 processes image data of a static image or video obtained by an image capture apparatus (such as, a camera) in a video capture mode or an image capture mode. A processed image frame may be displayed on the display unit 116. The image frame processed by the graphics processing unit 1141 may be stored in the memory 119 (or another storage medium) or sent by using the radio frequency unit 111 or the network module 112. The microphone 1142 may receive sound and can process such sound into audio data. The processed audio data may be converted in a call mode into a format that can be sent by the radio frequency unit 111 to a mobile communication base station for outputting.

The terminal 110 further includes at least one sensor 115, for example, a light sensor, a motion sensor, and another sensor. In some embodiments, the light sensor includes an ambient light sensor and a proximity sensor. The ambient light sensor may adjust the luminance of the display panel 1161 based on the brightness of ambient light. The proximity sensor may turn off the display panel 1161 and/or backlight when the terminal 110 is moved to an ear. As a type of the motion sensor, an accelerometer sensor may detect an acceleration value in each direction (generally, three axes), and detect a value and a direction of gravity when the accelerometer sensor is static, and may be used in an application for recognizing a mobile terminal posture (such as screen switching between landscape and portrait modes, a related game, or magnetometer posture calibration), a function related to vibration recognition (such as a pedometer or a knock), and the like. The sensor 115 may further include a fingerprint sensor, a pressure sensor, an iris sensor, a molecular sensor, a gyroscope, a barometer, a hygrometer, a thermometer, an infrared sensor, and the like. Details are not described herein.

The display unit 116 is configured to display information input by a user or information provided fora user. The display unit 116 may include a display panel 1161. The display panel 1161 may be configured in a form of a liquid crystal display (LCD), an organic light-emitting diode (OLED), or the like.

The user input unit 117 may be configured to receive input digit or character information and generate key signal input related to user setting and function control of the terminal. In some embodiments, the user input unit 117 includes a touch panel 1171 and another input device 1172. The touch panel 1171 is also referred to as a touchscreen, and may collect a touch operation performed by a user on or near the touch panel 1171 (for example, an operation performed by a user on the touch panel 1171 or near the touch panel 1171 by using any proper object or accessory, for example, a finger or a stylus). The touch panel 1171 may include two parts: a touch detection apparatus and a touch controller. The touch detection apparatus detects a touch location of the user, detects a signal brought by the touch operation, and sends the signal to the touch controller. The touch controller receives touch information from the touch detection apparatus, converts the touch information into touch point coordinates, sends the touch point coordinates to the processor 1110, and receives and executes a command sent by the processor 1110. In addition, the touch panel 1171 may be implemented in various types such as a resistor, a capacitor, an infrared ray, or a surface acoustic wave. The user input unit 117 may include other input devices 1172 in addition to the touch panel 1171. In some embodiments, the another input device 1172 may include but is not limited to: a physical keyboard, function keys (for example, a volume control key and an on/off key), a trackball, a mouse, or a joystick. Details are not described herein.

Further, the touch panel 1171 may cover the display panel 1161. After detecting the touch operation for or near the touch panel 1171, the touch panel 1171 transmits the touch operation to the processor 1110 to determine a type of a touch event, and then the processor 1110 provides a corresponding visual output on the display panel 1161 based on the type of the touch event. In FIG. 11, the touch panel 1171 and the display panel 1161 are used as two independent components to implement input and output functions of the terminal. However, in some embodiments, the touch panel 1171 and the display panel 1161 may be integrated to implement the input and output functions of the terminal. This is not specifically limited herein.

The interface unit 118 is an interface connecting an external apparatus to the terminal 110. For example, the external apparatus may include a wired or wireless headphone port, an external power (or battery charger) port, a wired or wireless data port, a memory card port, a port for connecting an apparatus provided with a recognition module, an audio input/output (I/O) port, a video I/O port, an earphone port, and the like. The interface unit 118 may be configured to receive input (for example, data information and power) from the external apparatus and transmit the received input to one or more elements in the terminal 110, or may be configured to transmit data between the terminal 110 and the external apparatus.

The memory 119 may be configured to store a software program and various data. The memory 119 may mainly include a program storage area and a data storage area. The program storage area may store an operating system, an application required by at least one function (for example, a sound play function or an image display function), and the like. The data storage area may store data (for example, audio data or an address book) or the like created based on use of a mobile phone. In addition, the memory 119 may include a high-speed random access memory, and may further include a nonvolatile memory, for example, at least one magnetic disk storage device, a flash storage device, or another volatile solid-state storage device.

The processor 1110 is a control center of the terminal, and connects all parts of the entire terminal by using various interfaces and lines. By running or executing a software program and/or a module stored in the memory 119 and invoking, data stored in the memory 119, the processor performs various functions of the terminal and data processing, to perform overall monitoring on the terminal. The processor 1110 may include one or more processing units. In some embodiments, an application processor and a modem processor may be integrated into the processor 1110. The application processor mainly processes an operating system, a user interface, an application program, and the like. The modem processor mainly processes wireless communications. It can be understood that the modern processor may not be integrated into the processor 1110.

The terminal 110 may further include the power supply 1111 (such as a battery) that supplies power to each component. In some embodiments, the power supply 1111 may be logically connected to the processor 1110 by using a power management system, so as to implement functions such as charging, discharging, and power consumption management by using the power management system.

In addition, the terminal 110 includes some function modules not shown, and details are not described herein.

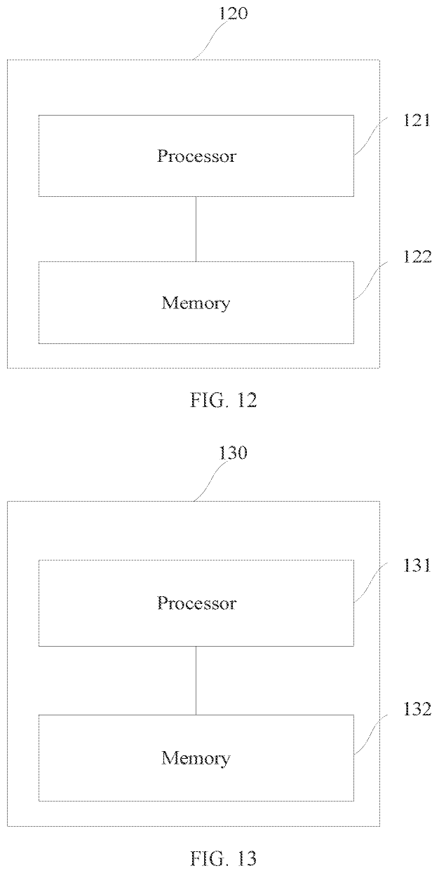

Referring to FIG. 12, an embodiment of the present disclosure further provides a terminal 120, including a processor 121, a memory 122, and a computer program stored in the memory 122 and executable on the processor 121. When the computer program is executed by the processor 121, each process of the scheduling method embodiments performed by the terminal can be implemented, and a same technical effect can be achieved. To avoid repetition, details are not described herein.

Referring to FIG. 13, an embodiment of the present disclosure further provides a terminal 130, including a processor 131, a memory 132, and a computer program stored in the memory 132 and executable on the processor 131, When the computer program is executed by the processor 131, each process of the scheduling method embodiments performed by the network side device can be implemented, and a same technical effect can be achieved. To avoid repetition, details are not described herein.

Embodiments of the present disclosure further provide a computer readable storage medium. The computer readable storage medium stores a computer program. The computer program implements, when executed by a processor, each process of the scheduling method embodiments, and a same technical effect can be achieved. To avoid repetition, details are not described herein again. The computer-readable storage medium is, for example, a Read-Only Memory (ROM), a Random Access Memory (RAM), a magnetic disk, or an optical disc.

It should be noted that, in this specification, the terms “include”, “comprise”, or any of their variants are intended to cover a non-exclusive inclusion, such that a process, a method, an article, or an apparatus that includes a list of elements not only includes those elements but also includes other elements that are not expressly listed, or further includes elements inherent to such process, method, article, or apparatus. Without more restrictions, an element defined by the statement “including a . . . ” does not exclude another same element in this process, method, article, or apparatus that includes the element.

By means of the foregoing description of the embodiments, a person skilled in the art may clearly understand that the method in the foregoing embodiments may be implemented by software in addition to a necessary universal hardware platform. The method in the foregoing embodiments may also be implemented by hardware. However, in many cases, the former is a preferred embodiment. Based on such an understanding, the technical solutions of the present disclosure essentially or the part contributing to existing technologies may be implemented in a form of a software product. The computer software product is stored in a storage medium (such as a ROM/RAM, a magnetic disk, or an optical disc) and includes several instructions for instructing a terminal (which may be a mobile phone, a computer, a server, an air conditioner, or a network device) to execute the methods described in the embodiments of the present disclosure.

The embodiments of the present disclosure are described above with reference to the accompanying drawings, but the present disclosure is not limited to the foregoing specific implementations. The foregoing specific implementations are merely exemplary instead of restrictive. Under enlightenment of the present disclosure, a person of ordinary skill in the art may make many forms without departing from the objective of the present disclosure and the protection scope of claims, all of which fall within the protection of the present disclosure.

1. A scheduling method, performed by a terminal, comprising:
obtaining scheduling configuration information; and
monitoring scheduling information of at least two scheduling objects to schedule one scheduled object based on the scheduling configuration information.

2. The scheduling method according to claim 1, wherein the monitoring scheduling information of at least two scheduling objects to schedule one scheduled object based on the scheduling configuration information comprises:
monitoring a search space on the scheduled object or the scheduling objects based on quantity information or type information of search space monitoring in the scheduling configuration information.

3. The scheduling method according to claim 2, wherein the quantity information or the type information of search space monitoring comprises at least one of the following:
not monitoring a UE-specific search space on the scheduled object;
a quantity of UE-specific search spaces monitored on the scheduled object does not exceed a first value;
not monitoring a unicast schedule on a common search space of the scheduled object;
a quantity of UE-specific search spaces monitored on the scheduling objects does not exceed a second value;
only monitoring a specific UE-specific search space on the scheduling objects, and a quantity of monitored UE-specific search spaces does not exceed a third value;
a sum of the UE-specific search spaces monitored on the scheduled object and the quantity of UE-specific search spaces monitored on the scheduling objects does not exceed a fourth value;
a sum of a quantity of common search spaces monitored on the scheduled object and the quantity of UE-specific search spaces monitored on the scheduling objects does not exceed a first value; or
a sum of a quantity of search spaces monitored on the scheduled objects and the quantity of UE-specific search spaces monitored on the scheduling objects does not exceed a sixth value.

4. The scheduling method according to claim 1, wherein the monitoring scheduling information of at least two scheduling objects to schedule one scheduled object based on the scheduling configuration information comprises:
monitoring the search space on the scheduled object or the scheduling objects based on sequence information of search space monitoring in the scheduling configuration information.

5. The scheduling method according to claim 4, wherein the sequence information of search space monitoring comprises at least one of the following:
during a specific time, not simultaneously monitoring the search space on the scheduled object and the search space on the scheduling objects; or
during a specific time, monitoring, based on a priority rule, the search space of the scheduled object and all search spaces on the scheduling objects for scheduling the scheduled object.

6. The scheduling method according to claim 5, wherein the priority rule comprises at least one of the following:
monitoring a common search space preferentially;
monitoring a search space on a specific object preferentially;
monitoring a search space with a lowest or highest ID preferentially;
monitoring a search space associated with a specific DCI format preferentially; or
monitoring a search space based on an ID order.

7. The scheduling method according to claim 1, wherein the monitoring scheduling information of at least two scheduling objects to schedule one scheduled object based on the scheduling configuration information comprises:
monitoring a unicast schedule of the scheduled object based on quantity information or type information of a unicast schedule in the scheduling configuration information.

8. The scheduling method according to claim 7, wherein the quantity information or type information of a unicast schedule comprises at least one of the following:
monitoring at most one or two unicast schedules associated with the scheduled object within a specific time;
monitoring at most one unicast schedule associated with the scheduled object on each object within a specific time; or
monitoring a specific type of unicast schedule associated with the scheduled object preferentially within a specific time.

9. The scheduling method according to claim 8, wherein the specific type of unicast schedule comprises: a unicast schedule in a specific DCI format.

10. The scheduling method according to claim 5, wherein the specific time comprises at least one of the following:
within a same moment;
within a same slot;
within a specific time interval;
a PDCCH monitoring occasion having a same earliest starting position for scheduling a PDSCH or a PUSCH; or
within a running time of a monitoring timer.

11. The scheduling method according to claim 1, wherein the scheduling configuration information further comprises:
in a plurality of times of transmission for a same HARQ process or a same TB, only allowing scheduling from the same scheduling object.

12. The scheduling method according to claim 1, wherein the scheduling configuration information further comprises:
if an ID of a first search space on the scheduled object is the same as an ID of a second search space on the scheduling objects, but the first search space is a common search space, considering that the first search space and the second search space are not associated.

13. The scheduling method according to claim 3, further comprising:
reporting a terminal capability, wherein the terminal capability comprises at least one of the following:
a quantity of monitored search spaces supported by the terminal;
a quantity of unicast schedules supported by the terminal;
whether the terminal supports scheduling the scheduled object through the scheduling objects;
a quantity of HARQ processes associated with each object;
an earliest starting position of a scheduled PDSCH or PUSCH; or
a duration of a specific time interval or a monitoring timer.

14. The scheduling method according to claim 1, wherein the scheduled object is a PCell, and the scheduled objects comprise a SCell.

15. A terminal comprising:
a memory storing a computer program; and
a processor coupled to the memory and configured to execute the computer program to perform operations comprising:
obtaining scheduling configuration information; and
monitoring scheduling information of at least two scheduling objects to schedule one scheduled object based on the scheduling configuration information.

16. The terminal according to claim 15, wherein the monitoring scheduling information of at least two scheduling objects to schedule one scheduled object based on the scheduling configuration information comprises:
monitoring a search space on the scheduled object or the scheduling objects based on quantity information or type information of search space monitoring in the scheduling configuration information.

17. The terminal according to claim 15, wherein the monitoring scheduling information of at least two scheduling objects to schedule one scheduled object based on the scheduling configuration information comprises:
monitoring the search space on the scheduled object or the scheduling objects based on sequence information of search space monitoring in the scheduling configuration information.

18. The terminal according to claim 15, wherein the monitoring scheduling information of at least two scheduling objects to schedule one scheduled object based on the scheduling configuration information comprises:
monitoring a unicast schedule of the scheduled object based on quantity information or type information of a unicast schedule in the scheduling configuration information.

19. The terminal according to claim 15, wherein the scheduling configuration information further comprises:
in a plurality of times of transmission for a same HARQ process or a same TB, only, allowing scheduling from the same scheduling object.

20. A non-transitory computer-readable storage medium, storing a computer program, wherein the computer program, when executed by a processor, performs operations comprising:
obtaining scheduling configuration information; and
monitoring scheduling information of at least two scheduling objects to schedule one scheduled object based on the scheduling configuration information.
